(19) United States
(12) Patent Application Publication
(10) Pub. No.: US 2017/0277392 A1
(43) Pub. Date: Sep. 28, 2017

(54) VEHICLE MAP ICON

(71) Applicant: THE BOEING COMPANY, Chicago, IL (US)

(72) Inventor: Joshua Lee DOWNS, St. Charles, MO (US)

(21) Appl. No.: 15/079,465

(22) Filed: Mar. 24, 2016

(51) Int. Cl. G06F 3/0481; G01C 21/36; G01C 21/34; G06F 3/0482; G06F 17/30

(52) U.S. Cl. CPC G06F 3/04817; G06F 3/0482; G06F 17/30241; G01C 21/343; G01C 21/3697

(57) ABSTRACT

A method, system, and computer program product for generating a graphical icon for a vehicle carrying a payload is provided. The graphical icon includes a first icon portion that indicates a status of the first deployable payload, which can include several separately deployable sub-payloads. The graphical icon also includes a second icon portion that indicates the vehicle. The second icon portion is arranged relative to the first icon portion to indicate a direction of travel of the vehicle. The second icon portion may be smaller than the first icon portion to emphasize the payload status. The graphical icon is generated based on information about the vehicle and payload received from the vehicle. The generated graphical icon can be displayed on a computer display, such as on a top-down view map display in which the generated icon is overlaid on the map at the location of the vehicle and its payload.

### BACKGROUND

Movement of vehicles, such as manned and unmanned aerial vehicles, are sometimes monitored using a top-down map display in which icons representing vehicles are overlaid. In many instances, the vehicles are carrying payloads to be deployed during operation. The payload or payloads being carried by the vehicle, and the statuses of the payloads, may be critical information. However, current iconography used on the above described top-down map displays do not provide detailed information (if any information is provided at all) about the payload or payloads on board vehicles. Often times, personnel monitoring the vehicles must consult a separate display screen or another information source to identify the payloads and/or the statuses of the payloads.

### SUMMARY

According to one aspect, a system includes a computer processor. The system also includes an input operable to receive first indications of positions and directions of travel of a first vehicle and second indications of statuses of a first deployable payload onboard the first vehicle. The system also includes a computer memory storing a computer-generated image of a region in which the first vehicle is operating. The computer memory also stores an application that, when executed by the computer processor, generates a first graphical icon. The first graphical icon includes a first icon portion indicating the statuses of the first deployable payload. The first graphical icon also a second icon portion indicating the first vehicle. The second icon portion is arranged relative to the first icon portion based on the direction of travel of the first vehicle. The second icon portion is smaller than the first icon portion. The application also outputs the computer-generated image with the generated first graphical icon superimposed on the generated computer image at a location that coincides with the position of the first vehicle. The system also includes a computer display operable to display the output computer-generated image and the generated first graphical icon.

According to one aspect, a computer program product for calculating a predicted abnormal operation of a machine is provided. The computer program product includes a computer-readable storage medium having computer-readable program code embodied therewith. The computer-readable program code is executable by one or more computer processors to receive a first indication of a position and direction of travel of a first vehicle. The computer-readable program code is also executable to receive a second indication of a status of a first deployable payload onboard the first vehicle. The computer-readable program code is also executable to generate a first graphical icon. The first graphical icon includes a first icon portion indicating the status of the first deployable payload. The first graphical icon also includes a second icon portion indicating the first vehicle. The second icon portion is arranged relative to the first icon portion based on the direction of travel of the first vehicle. The second icon portion is smaller than the first portion. The computer-readable program code is also executable to generate a computer image indicating a region in which the first vehicle is operating. The computer-readable program code is also executable to output to a computer display the generated computer image and the generated first graphical icon, wherein the generated first graphical icon is superimposed on the generated computer image at a location that coincides with the position of the first vehicle.

According to one aspect, a computer-implemented method for generating an icon is provided. The method includes receiving a first indication of a position and direction of travel of a first vehicle. The method also includes receiving a second indication of a first status of a first deployable payload onboard the first vehicle. The method also includes generating a first graphical icon. The first graphical icon includes a first icon portion indicating the status of the first deployable payload. The first graphical icon also includes a second icon portion indicating the first vehicle. The second icon portion is arranged relative to the first icon portion based the direction of travel of the first vehicle. The second icon portion is smaller than the first icon portion. The method also includes generating a computer image indicating a region in which the first vehicle is operating. The method also includes outputting to a computer display the generated computer image and the generated first graphical icon, wherein the generated first graphical icon is superimposed on the generated computer image at a location that coincides with the position of the first vehicle.

### BRIEF DESCRIPTION OF THE DRAWINGS

FIG. 1 is a view of an exemplary image on a display screen of a geographic region with graphical icons representing vehicles and payloads of the vehicles according to one aspect;

FIG. 2A is a view of an exemplary graphical icon according to another aspect;

FIG. 2B is a view of an exemplary graphical icon according to another aspect;

FIG. 2C is a view of an exemplary graphical icon according to the aspect shown in FIG. 2A or the aspect shown in FIG. 2B and indicating a zero payload condition;

FIG. 3 is a view of an exemplary graphical icon according to another aspect;

FIG. 4 is a view of an exemplary graphical icon according to another aspect and including a dialog box providing additional details related to a payload;

FIG. 5 is a view of an exemplary graphical icon according to another aspect;

FIG. 6 is a view of an exemplary image on a display screen of a geographic region with graphical icons representing vehicles and payloads of the vehicles according to one aspect, and also displaying planned routes for the vehicles with deployment locations for the payloads;

FIG. 7 is a block diagram of a system according to one aspect for generating graphical icons illustrating vehicles and their respective payloads; and

FIG. 8 is a flow chart for a method for generating graphical icons illustrating vehicles and their respective payloads.

### DETAILED DESCRIPTION

In the following, reference is made to aspects presented in this disclosure. However, the scope of the present disclosure is not limited to specific described aspects. Instead, any combination of the following features and elements, whether related to different aspects or not, is contemplated to implement and practice contemplated aspects. Furthermore, although aspects disclosed herein may achieve advantages over other possible solutions or over the prior art, whether or not a particular advantage is achieved by a given aspect is not limiting of the scope of the present disclosure. Thus, the following aspects, features, and advantages are merely illustrative and are not considered elements or limitations of the appended claims except where explicitly recited in a claim(s). Likewise, reference to “the invention” or “the disclosure” shall not be construed as a generalization of any inventive subject matter disclosed herein and shall not be considered to be an element or limitation of the appended claims except where explicitly recited in a claim(s).

In aspects described herein, graphical icons for computer map displays that emphasize payloads carried by vehicles are generated (e.g., for use on a top-down view map display). A user can interact with the icons to get detailed information about the payloads and/or the statuses of the payloads. The iconography described herein allows the user or users to consult a single display screen to determine the status of the vehicle and the status of the payloads.

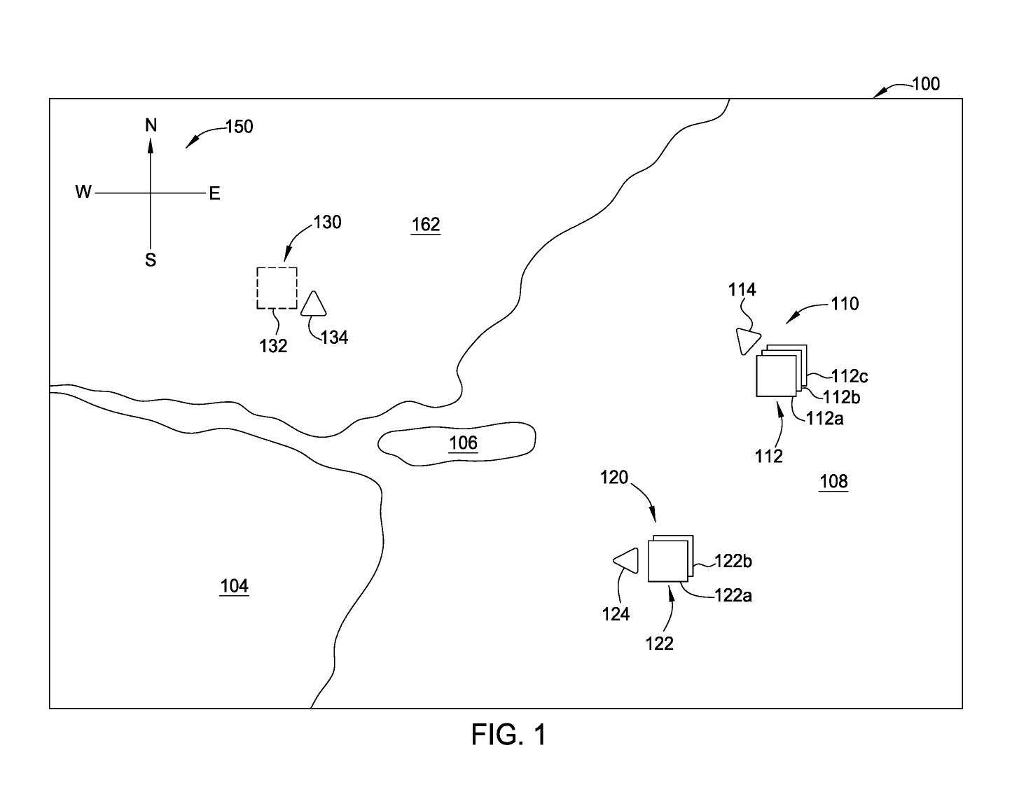

FIG. 1 depicts an image 100 for display on a computer display screen. The image 100 is a top-down view of a map display on a computer display screen. The exemplary map display includes several land masses 102, 104, and 106 and a body of water 108. The image 100 also includes a compass rose 150 indicating the cardinal directions. The image 100 includes an exemplary first graphical icon 110 for a first vehicle, an exemplary second icon 120 for a second vehicle, and an exemplary third icon 130 for a third vehicle.

The exemplary first graphical icon 110 includes a first icon portion 112 and a second icon portion 114. The exemplary first icon portion 112 includes three graphical tiles 112a, 112b, and 112c. The three graphical tiles 112a, 112b, and 112c represent three sub-payloads being carried by the first vehicle. The second icon portion 114 of the exemplary first graphical icon 110 is an arrow that is positionable around a periphery of the first icon portion 112 to indicate a direction of travel of the first vehicle. In the scenario depicted in the image 100, the vehicle represented by the exemplary first graphical icon 110 is traveling in a Northwest direction (i.e., approximately on a heading of 315°). The exemplary first graphical icon 110 is positioned relative to the land masses 102, 104, 106 and the body of water 108 in the image 100 to match the real-world position of the first vehicle. For example, the vehicle may determine its latitude and longitude from a global positioning system (GPS), an inertial navigation system (INS), or other navigation system and can transmit its determined latitude and longitude to a system generating the image 100. The direction of travel of the vehicle, indicated by the second icon portion 114, can also be determined from a GPS, an INS, or other navigation system, which can be transmitted to the system generating the image 100.

The exemplary second icon 120 includes a third icon portion 122 and a fourth icon portion 124. The exemplary third icon portion 122 includes two graphical tiles 122a and 122b. The two graphical tiles 122a and 122b represent two sub-payloads being carried by the second vehicle. The fourth icon portion 124 of the exemplary second icon 120 is an arrow that is positioned around the periphery of the third icon portion 122 to indicate a direction of travel of the second vehicle. In the scenario depicted in the image 100, the second vehicle represented by the exemplary second icon 120 is traveling in a West direction (i.e., approximately on a heading of 270°). The exemplary second icon 120 is positioned relative to the land masses 102, 104, 106 and the body of water 108 in the image 100 to match the real-world position of the second vehicle.

The exemplary third icon 130 includes a fifth icon portion 132 and a sixth icon portion 134. The exemplary fifth icon portion 132 is a graphical tile in broken line, which indicates that the payload for the third vehicle has been released, used, or otherwise spent. Instead of the illustrated broken line format, the graphical tile for the fifth icon portion 132 could be produced in a different graphical sub-state (e.g., color) than the graphical tiles for the first graphical icon 110 and the second icon 120, could be at least partly transparent or could have another visual differentiation to denote that the payloads have been used or deployed. The sixth icon portion 134 of the exemplary third icon 130 is an arrow that is positioned around the periphery of the fifth icon portion 132 to indicated direction of travel of the third vehicle. In the scenario depicted in the image 100, the third vehicle represented by the exemplary third icon 130 is traveling in a South East direction (i.e., approximately on a heading of 110°). The exemplary third icon 130 is positioned relative to the land masses 102, 104, and 106 and the body of water 108 in the image 100 to match the real-world position of the third vehicle.

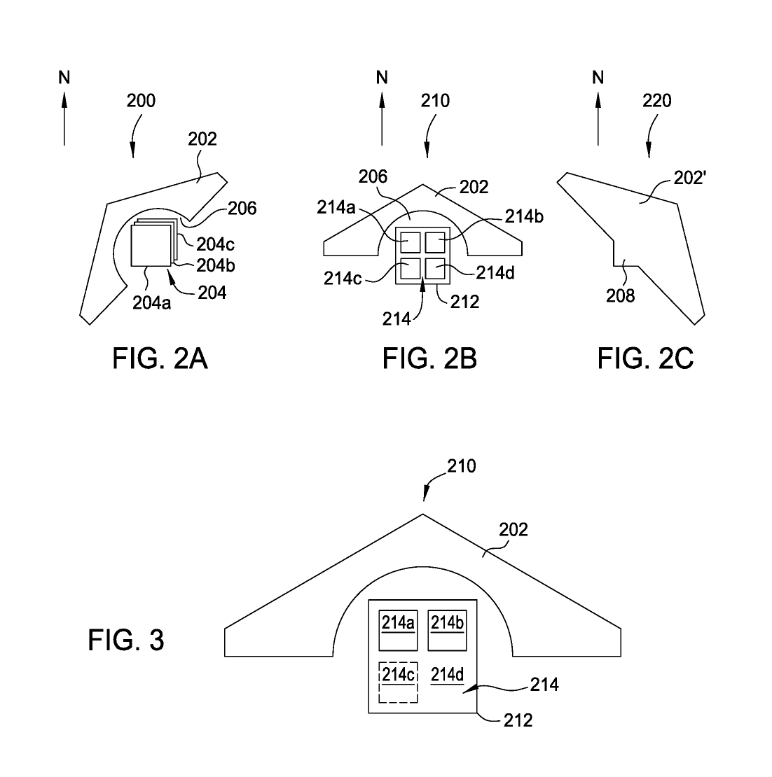

FIGS. 2A-2C illustrate other aspects of a graphical icon depicting a vehicle and payloads carried by the vehicle. FIG. 2A illustrates an icon 200 according to one aspect that includes a first icon portion 204 that includes graphical tiles 204a, 204b, and 204c, which represent payloads for the vehicle. The icon 200 also includes a second icon portion 202 that partly surrounds the first icon portion 204 and has a wing shape to represent an aircraft. In various aspects, the second icon portion 202 could have other shapes to represent other vehicle types or models (e.g., a car, a truck, a ship, or a boat). The second icon portion 202 includes a recess 206 in which the first icon portion 204 is arranged. The second icon portion 202 is oriented relative to the first icon portion 204 to indicate the direction of travel. Similar to the exemplary first graphical icon 110, the exemplary second icon 120, and the exemplary third icon 130 FIG. 1, the second icon portion 202 can be rotated about the first icon portion 204 to indicate the direction of travel. As illustrated in FIG. 2A, the second icon portion 202 is rotated about the first icon portion 204 to indicate a Northwest direction of travel (i.e., approximately on a heading of 315°).

FIG. 2B illustrates an icon 210 according to one aspect that includes a different first icon portion 212 arranged with the second icon portion 202 illustrated in FIG. 2A. The different first icon portion 212 includes an icon field 214 that includes four graphical tiles 214a, 214b, 214c, and 214d arranged in an array. The four graphical tiles 214a, 214b, 214c, and 214d represent sub-payloads carried by the vehicle. The four graphical tiles 214a, 214b, 214c, and 214d can be individually modified to reflect changes to the statuses of the respective sub-payloads. For example, the four graphical tiles 214a, 214b, 214c, and 214d could change graphical sub-states (e.g., colors, change opacity, or change from a solid line to a broken line) to denote different sub-payload statuses. The second icon portion 202 can be rotated around the first icon portion 212 to indicate the direction of travel of the vehicle represented by the icon 210. As illustrated in FIG. 2B, the second icon portion 202 is rotated about the first icon portion 212 to indicate a North direction of travel (i.e., approximately on a heading of 360°).

FIG. 2C illustrates an icon 220 according to one aspect for a vehicle that is not carrying any payloads. For example, the vehicle may have released its payloads or used up the capacity of its payloads. In the latter case, a payload could be a sensor package that includes onboard storage of sensor readings, and the onboard storage could be full, for example. The icon 220 includes a modified second icon portion 202′ in which the recess 206 has been replaced with a filled in portion 208. As illustrated in FIG. 2C, the modified second icon portion 202′ is rotated to indicate a northeast direction of travel (i.e., approximately on a heading a 45°).

FIG. 3 illustrates the icon 210 in an exemplary scenario in which two of four sub-payloads are ready to be deployed, one of the sub-payloads is not ready to be deployed, and one of the sub-payloads has been deployed. The icon 210 includes two graphical tiles 214a and 214b in the icon field 214 that are rendered in solid line, indicating that the associated sub-payloads are in a ready-to-be-deployed state. The icon 210 includes one graphical tile 214c that is rendered in broken line, indicating that the associated sub-payload is in a not-ready-to-be-deployed state. The icon field 214 includes one open space (indicated by reference number 214d), indicating that an associated sub-payload has already been deployed (or that a sub-payload was not included on the vehicle). The states of the sub-payloads are indicated in the exemplary icon 210 using solid lines and broken lines. However, other visual schemes can be used to distinguish different statuses of sub-payloads. For example, the graphical tiles 214a, 214b, 214c, and 214d could be rendered in different graphical sub-states (e.g., different colors, different opacities, different textures, and/or different patterns) to denote different statuses. As another example, the tiles could be rendered in a flashing manner to indicate a not ready state and in a steady manner to indicate a ready state as a location for delivery or deployment of the payload is being approached.

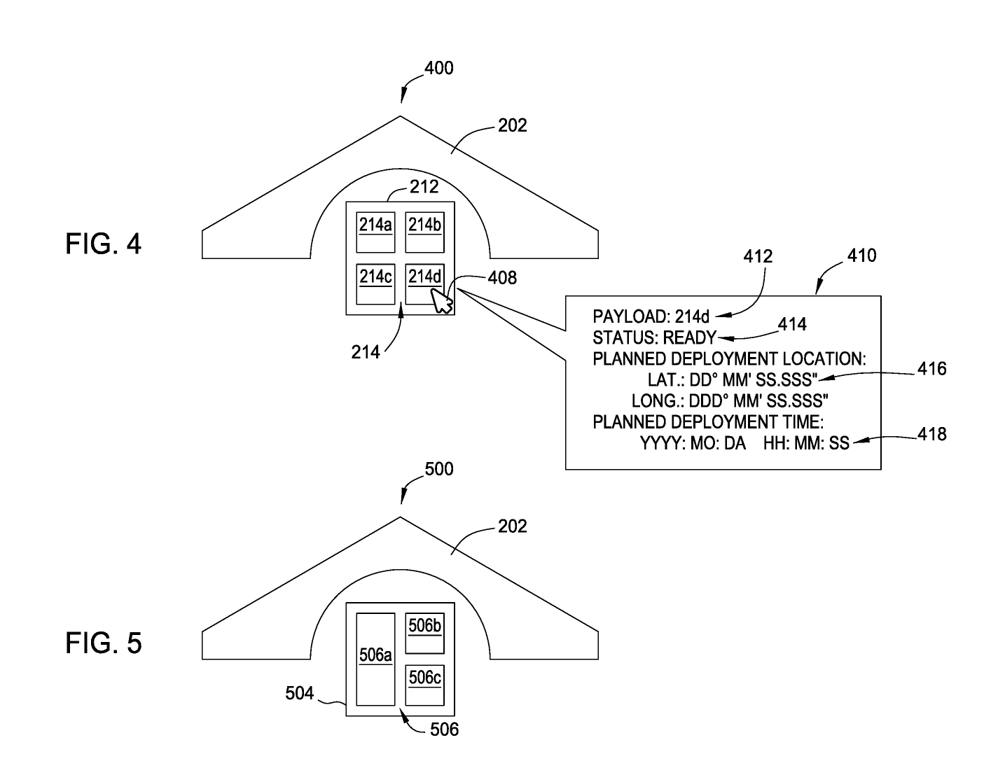

In various aspects, a user may interact with graphical representations of a payload and/or sub-payloads in the vehicle icon to identify the sub-payloads, the states of the sub-payloads, and/or deployment details for the sub-payloads. FIG. 4 illustrates an exemplary icon 400 that includes the first icon portion 212 and the second icon portion 202 from FIG. 2B. FIG. 4 also illustrates a computer cursor 408 that is movable by a user (e.g., using a computer mouse, computer stylus, or other input device). The computer cursor 408 is illustrated as hovering over the graphical tile 214d representing one of the sub-payloads. In response to the computer cursor 408 hovering over the graphical tile 214d and/or in response to the user providing an input (e.g., clicking a button on the computer mouse or other input device) while the computer cursor 408 is hovering over the graphical tile 214d, a dialogue box 410 is generated on a computer display screen (e.g., as part of the image 100 in FIG. 1).

The exemplary dialog box 410 includes a payload identifier field 412. In the exemplary dialog box 410, the payload identifier field 412 repeats the reference number 214d. In various aspects, the payload identifier field 412 could identify a sensor package, a deliverable sub-payload, or other identifying details of a sub-payload.

The exemplary dialog box 410 also includes a status or state field 414. In the exemplary dialog box 410, the status or state field 414 indicates a status or state of “ready.” Other exemplary statuses or states include “not ready,” “warming up,” “warmed up,” “recording,” and “memory full,” for example.

The exemplary dialog box 410 also includes a deployment location field 416 that can identify the planned deployment location (e.g., in terms of latitude and longitude) where the sub-payload is to be deployed. Optionally, the deployment location field 416 can also include an altitude at which the sub-payload is to be deployed. In instances in which a sub-payload is to be dropped, the location provided in the deployment location field 416 could be a location at which the sub-payload is to be released. In instances in which a sub-payload is used over a period of time, such as a sensor package, the deployment location field 416 could include a start location at which use of the sub-payload is planned to begin and a stop location at which use of the sub-payload is planned to end.

The exemplary dialog box 410 also includes a deployment time field 418. In the exemplary dialog box 410, the deployment time field 418 includes a time, expressed as a date and time of day, at which the sub-payload is to be deployed. In instances in which a sub-payload is to be dropped, the time provided in the deployment time field could be a time at which the sub-payload is to be released. In instances in which a sub-payload is to be used over a period of time, such as the sensor package discussed above, the deployment time field 418 could include a start time at which time use of the sub-payload is planned to begin and a stop time at which time use of the sub-payload is planned to end.

In various aspects, a dialog box could include additional and/or different fields than those depicted in the exemplary dialog box 410 shown in FIG. 4. The suitable fields may depend on the particular sub-payload and/or the mission of the vehicle, for example.

In various aspects, an icon can include varying icon portions for different sub-payloads to indicate amounts of total payload capacity used by the respective sub-payloads. For illustration purposes, consider a cargo aircraft that is carrying a truck and two pallets of supplies. The truck may use half of the weight-carrying capability of the cargo aircraft and/or half of the cargo volume in the cargo aircraft. Likewise, the two pallets of supplies may each use one quarter of the weight carrying capability of the cargo aircraft and/or a quarter of the cargo volume in the cargo aircraft. FIG. 5 illustrates an exemplary icon 500 in which a first icon portion 504 includes an icon field 506 with graphical tiles sized based on the exemplary scenario described above with the cargo aircraft. The icon field 506 includes a first graphical tile 506a that occupies approximately half of the icon field 506 and which represents the truck being carried by the cargo aircraft. The icon field 506 includes a second graphical tile 506b and a third graphical tile 506c that represent the two respective pallets of supplies carried by the cargo aircraft.

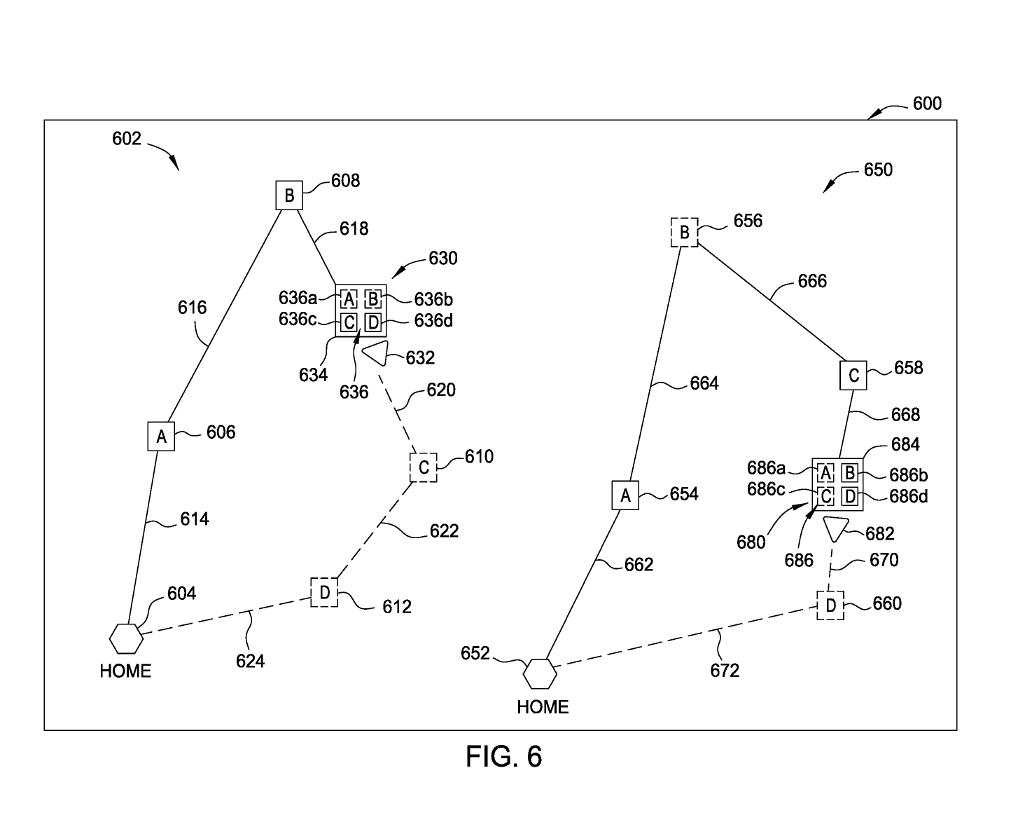

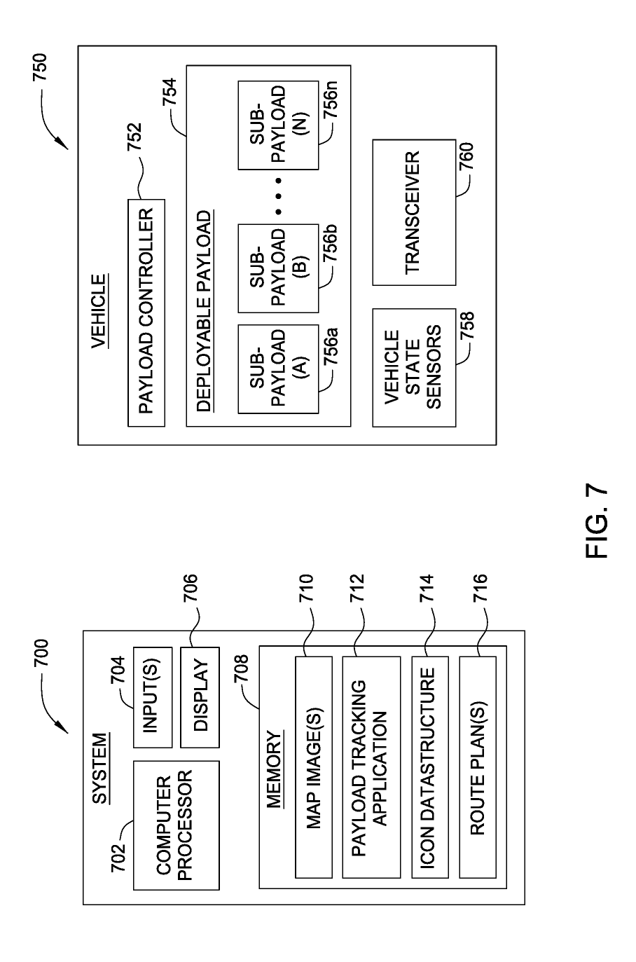

In various aspects, the sub-payload icons could be used in conjunction with a map display to indicate mission progress for a vehicle. FIG. 6 illustrates an image 600 of a top-down view map display (geographical features have been omitted for clarity) that includes an exemplary first planned route 602 for a first vehicle and an exemplary second planned route 650 for a second vehicle.

In the exemplary first planned route 602, the first vehicle is planned to deploy four sub-payloads at four different locations. At the moment in time depicted in FIG. 6, the first vehicle has deployed the first two sub-payloads and is heading to a location to deploy the third sub-payload. The first planned route 602 begins and ends at a home location 604 (e.g., an airfield, parking lot, or boat slip). The first planned route 602 follows a first leg to a first location at which a first sub-payload is to be deployed. The first location is indicated by a first solid-line deployment marker 606 on the image 600, and the first leg from the home location 604 to the first deployment marker 606 is indicated by a solid line 614. The first planned route 602 then follows a second leg to a second location at which a second sub-payload is to be deployed. The second location is indicated by a second solid-line deployment marker 608 on the image 600, and the second leg from the first deployment marker 606 to the second deployment marker 608 is indicated by a solid line 616. The first deployment marker 606, the second deployment marker 608, the first line 614, and the second line 616 are depicted as solid lines because the vehicle has already successfully completed those legs and deployed the first and second sub-payloads. After deploying the second sub-payload at the location indicated by the second deployment marker 608, the planned route 602 then travels to a third location indicated by a third deployment marker 610 at which a third sub-payload is to be deployed. As depicted in the image 600, an icon 630 representing the vehicle and its sub-payloads is between the second location and the third location. As a result, a route from the second deployment marker 608 to the third deployment marker 610 is denoted by a solid line portion 618 between the second deployment marker 608 and the icon 630 (indicating the portion of the third leg already traveled by the vehicle represented by the icon 630) and a broken line portion 620 between the icon 630 and the third deployment marker 610 (indicating the portion of the third leg not yet traveled by the vehicle). The third deployment marker 610 is depicted as a broken line to indicate that the vehicle has not deployed the third sub-payload at the location indicated by the third deployment marker 610. After reaching the location indicated by the third deployment marker 610 and deploying the third sub-payload, the first planned route 602 follows a fourth leg to a fourth location at which a fourth sub-payload is to be deployed. After the fourth sub-payload is to be deployed, the first planned route 602 follows a fifth leg that returns to the home location 604. The fourth leg 622, the fourth deployment marker 612, and the fifth leg 624 are depicted as broken lines to indicate that the vehicle has not yet completed these parts the planned route 602.

The icon 630 for the first vehicle performing the first planned route 602 includes a first icon portion 634 indicating the statuses or states of the deployable sub-payloads and the second icon portion 632 indicating the direction of travel of the first vehicle. The second icon portion 632 is oriented around a periphery of the first icon portion 634 to indicate a direction of travel (in this scenario, approximately the same as the direction of the leg (indicated by the solid lines 618 and the broken lines 620) from the second deployment marker 608 to the third deployment marker 610). The first icon portion 634 includes an icon field 636 that includes four graphical tiles 636a, 636b, 636c, and 636d representing the four sub-payloads to be deployed at the locations indicated by the deployment markers 606, 608, 610, and 612. In the exemplary icon 630, the graphical tiles 636a, 636b, 636c, and 636d and deployment markers 606, 608, 610, and 612 include labels that allow a user or viewer of the image 600 to identify and/or associate sub-payloads with deployment locations indicated by the deployment markers 606, 608, 610, and 612. For example, the graphical tile 636a includes a label “A” and the first deployment marker 606 includes a label “A,” which visually indicates that the sub-payload associated with the graphical tile 636a is to be deployed at the location represented by the first deployment marker 606. Also, the graphical tile 636b includes a label “B” and the second deployment marker 608 includes a label “B,” which visually indicates that the sub-payload associated with the graphical tile 636b is to be deployed at the location represented by the second deployment marker 608. Also, the graphical tile 636c includes a label “C” and the third deployment marker 610 includes a label “C,” which visually indicates that the sub-payload associated with the graphical tile 636c is to be deployed at the location represented by the third deployment marker 610. Also, the graphical tile 636d includes a label “D” and the third deployment marker 612 includes a label “D,” which visually indicates that the sub-payload associated with the graphical tile 636d is to be deployed at the location represented by the fourth deployment marker 612. In the exemplar provided by the first planned route 602, since the sub-payloads associated with the graphical tiles 636a and 636b have been deployed, the graphical tiles 636a and 636b are rendered in broken line in the icon 630. By contrast, the sub-payloads associated with the graphical tiles 636c and 636d have not yet been deployed, so the graphical tiles 636c and 636d are rendered in solid line.

The iconography scheme described above with reference to the first planned route 602 (and variations thereof) can be used to readily ascertain deployment issues with various sub-payloads. The second planned route 650 is similar to the first planned route 602, but illustrates an exemplary scenario in which a sub-payload did not deploy as planned. Specifically, in the exemplary scenario, a first sub-payload “A” indicated by a graphical tile 686a successfully deployed at a location indicated by a first deployment marker 654 and a third sub-payload “C” indicated by a graphical tile 686c successfully deployed at a location indicated by a third deployment marker 658, but a second sub-payload “B” indicated by a graphical tile 686b was not successfully deployed at a location indicated by a second deployment marker 656.

In the exemplary second planned route 650, the second vehicle is planned to deploy four sub-payloads at four different locations. The first planned route 650 begins and ends at a home location 652 (e.g., an airfield, parking lot, or boat slip). The first planned route 650 follows a first leg to the first location at which the first sub-payload is to be deployed. The first location is indicated by the first solid-line deployment marker 654 on the image 600, and the first leg from the home location 652 to the first deployment marker 654 is indicated by a solid line 662. The second planned route 650 then follows a second leg to the second location at which the second sub-payload is to be deployed. The second location is indicated by the second deployment marker 656 on the image 600, and the second leg from the first deployment marker 654 to the second deployment marker 656 is indicated by a solid line 664. Since the second sub-payload “B” was not successfully deployed at the second location, the second deployment marker 656 is rendered in broken line. After traveling over the location indicated by the second deployment marker 656, the planned route 650 then travels along a third leg to the third location indicated by the third solid-line deployment marker 658 at which the third sub-payload “C” is to be deployed. The third leg is rendered as a solid line 666. After the third sub-payload “C” is deployed, the second planned route 650 then travels along a fourth leg to the fourth location indicated by the fourth broken-line deployment marker 660. As depicted in the image 600, an icon 680 representing the vehicle and its sub-payloads is between the third location and the fourth location. As a result, a route from the third deployment marker 658 to the fourth deployment marker 660 is denoted by a solid line portion 668 between the third deployment marker 658 and the icon 680 (indicating the portion of the fourth leg already traveled by the vehicle represented by the icon 680) and a broken line portion 670 between the icon 680 and the fourth deployment marker 660 (indicating the portion of the fourth leg not yet traveled by the vehicle). The fourth deployment marker 660 is depicted as a broken line to indicate that the vehicle has not yet reached the third deployment marker 660 and has not deployed the fourth sub-payload “D” at the location indicated by the fourth deployment marker 660. After reaching the location indicated by the fourth deployment marker 660 and deploying the fourth sub-payload “D,” the second planned route 650 follows a fifth leg that returns to the home location 652. The fourth deployment marker 660 and the fifth leg 672 are depicted as broken lines to indicate that the vehicle has not yet performed these parts the planned route 650.

The icon 680 for the second vehicle performing the second planned route 650 includes a first icon portion 684 indicating the statuses or states of the deployable sub-payloads and a second icon portion 682 indicating a direction of travel of the second vehicle. The second icon portion 682 is oriented around a periphery of the first icon portion 684 to indicate a direction of travel (that is approximately the same as the direction of the leg (indicated by the solid line 668 and the broken line 670) from the third deployment marker 658 to the fourth deployment marker 660). The first icon portion 684 includes an icon field 686, which includes four graphical tiles 686a, 686b, 686c, and 686d representing the four sub-payloads to be deployed at the locations indicated by the deployment markers 654, 656, 658, and 660. In the exemplary icon 680, the graphical tiles 686a, 686b, 686c, and 686d and deployment markers 654, 656, 658, and 660 include labels that allow a user or viewer of the image 600 to identify and/or associate sub-payloads and deployment locations indicated by the deployment markers 654, 656, 658, and 660. For example, the graphical tile 686a includes a label “A” and the first deployment marker 654 includes a label “A,” which visually indicates that the sub-payload associated with the graphical tile 686a is to be deployed at the location represented by the first deployment marker 654. Also, the graphical tile 686b includes a label “B” and the second deployment marker 656 includes a label “B,” which visually indicates that the sub-payload associated with the graphical tile 686b is to be deployed at the location represented by the second deployment marker 656. Also, the graphical tile 686c includes a label “C” and the third deployment marker 658 includes a label “C,” which visually indicates that the sub-payload associated with the graphical tile 686c is to be deployed at the location represented by the third deployment marker 658. Also, the graphical tile 686d includes a label “D” and the third deployment marker 660 includes a label “D,” which visually indicates that the sub-payload associated with the graphical tile 686d is to be deployed at the location represented by the fourth deployment marker 660. Here, since the sub-payloads associated with the graphical tiles 686a and 686c have been deployed, the graphical tiles 686a and 686c are rendered in broken line in the icon 680. By contrast, the sub-payloads associated with the graphical tiles 686b and 686d have not yet been deployed, so the graphical tiles 686b and 686d are rendered in solid line.

In the exemplary scenario depicted with reference to the second planned route 650, a user or viewer of the image 600 would be able to readily identify the missed deployment of the second sub-payload (B) at the location indicated by the second deployment marker 656.

FIG. 7 illustrates a system 700 for displaying a graphical icon that emphasizes a payload carried by a vehicle. The system 700 includes a computer processor 702 and a computer memory 708. The computer memory 708 stores one or more map images 710 for relevant operation areas in which a vehicle or vehicles may operate. For example, the computer memory 708 could store map images for a region in which one or more aircraft are going to operate. The map images could include terrain information, street information, and other location information, for example. The computer memory 708 also stores a payload tracking application 712 that receives payload information, location information, and direction of travel information from operating vehicles and generates graphical icons representing the vehicles and their respective payloads. The computer memory 708 can optionally include an icon data structure 714 that includes different icon symbols for different vehicles, different payloads, and/or different payload statuses. For example, the first icon portion 114 illustrated in FIG. 1 could be stored in the icon data structure 714 and could be used to represent an unmanned aerial vehicle. The second icon portion 202 illustrated in FIGS. 2A-2C, 3, 4, and 5 could also be stored in the icon data structure 714 and can be used to represent a manned aerial vehicle, for example. The icon data structure 714 could also store different icons representing different payload types (e.g., sensor packages and released payloads). The icon data structure 714 could also store different icons representing different statuses of the payloads. For example, the icon data structure 714 could include a green version of an icon and a red version of the icon. The red version of the icon could represent a payload that is not ready to be deployed and the green version of the icon could represent the payload when it is ready to be deployed. The computer memory 708 can also store route plans 716 for various vehicles. For example, the computer memory 708 could store the planned routes 602 and 650 illustrated in FIG. 6, including the sub-payloads to be deployed at various points along the routes.

The system 700 can also include a display 706 that can display the map images 710, planned routes 716, and the various icon data structures 714 as output by the payload tracking application 712 executing on the computer processor 702. The system 700 can also include one or more inputs 704. As discussed above with reference to FIG. 4, the input(s) 704 could include a computer mouse that can be used by a user to manipulate a cursor 408. The inputs 704 could also include a computer keyboard, a computer stylus, or other computer input interfaces. Inputs 704 could also include commands to change entries for new payload deliveries and entries to change the state of particular payloads, for example.

The inputs 704 can also include a transceiver or a data channel in communication with the transceiver for communicating with the various vehicles. For example, FIG. 7 illustrates a single vehicle 750 that could communicate with the inputs 704 via the transceiver 760. The vehicle 750 includes a payload controller 752 that can deploy a deployable payload 754. The exemplary vehicle 750 includes a sub-payload “A” 756a, a sub-payload “B” 756b, and sub-payload “N” 756n. The payload controller 752 is operable to monitor and control the status of the various sub-payloads and can control deployment of the sub-payloads. The payload controller 752 is further operable to communicate the status and deployment states of the sub-payloads to the transceiver 760, and the transceiver 760 can transmit such status and deployment state information to the inputs 704 of the system 700. The vehicle 750 also includes vehicle state sensors 758 that can gather information related to operation of the vehicle 750. For example, the vehicle state sensors 758 could be a global positioning system (GPS) that calculates a location and direction of travel of the vehicle. The vehicle state sensors 758 could also be an inertial navigation system (INS) to calculate a location and direction of travel of the vehicle.

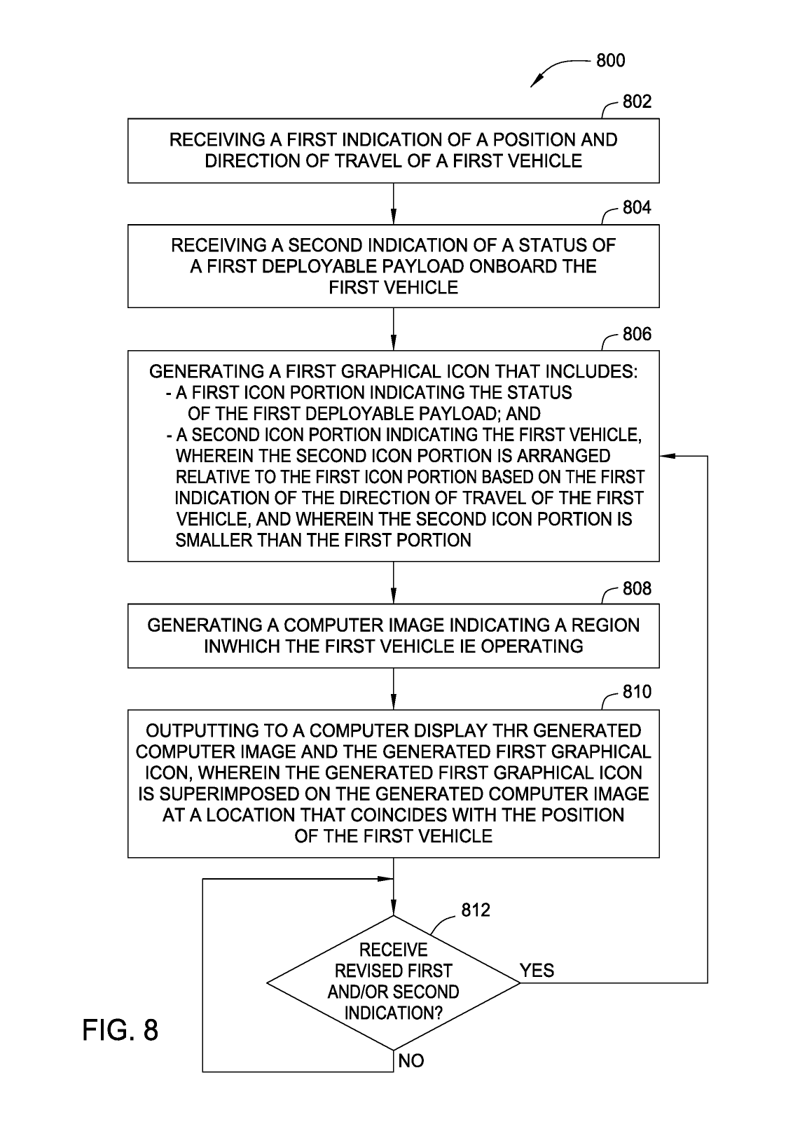

FIG. 8 is a flow chart for a method 800 for generating a graphical icon of the vehicle and its payload. In block 802 of the method 800, a first indication of a position and direction of travel of the first vehicle is received. In block 804, a second indication of the status of a first deployable payload on board the first vehicle is received. With reference to FIG. 7, the vehicle 750 can transmit to the system 700 a first indication of a position and direction of travel as determined by the vehicle state sensors 758 and a second indication of the status of the deployable payload 754 as determined by the payload controller 752. In block 806 of the method 800, a first graphical icon is generated. The first graphical icon includes a first icon portion indicating the status of the first deployable payload and a second icon portion indicating the first vehicle. The second icon portion is arranged around a periphery of the first icon portion based on the first indication of the direction of travel of the vehicle. Referring again to FIG. 1, for example, the graphical icon 110 includes a first icon portion 112 and a second icon portion 114. The second icon portion 114 is positioned about the first icon portion 112 at 315°, indicating that the vehicle represented by the first graphical icon 110 is traveling in a Northwest direction. According to one aspect of the method 800, the second icon portion is smaller than the first icon portion to emphasize the payload status. In block 808, a computer image is generated indicating a region in which the first vehicle is operating. In block 810, the generated computer image and the generated first graphical icon are output to a computer display. The generated graphical icon is superimposed on the generated computer image at a location that coincides with the position of the first vehicle in the region. In block 812 the query is made to determine whether a revised first and/or second indication has been received. In the event that a revised first and/or second indication has not been received, then the method 800 repeats block 812. When a revised first and/or second indication has been received, the method returns to block 806 to re-generate the first graphical icon based on the revised first and/or second indication. Multiple instances of the method 800 can be performed for multiple vehicles.

The descriptions of the various aspects have been presented for purposes of illustration, but are not intended to be exhaustive or limited to the aspects disclosed. Many modifications and variations will be apparent to those of ordinary skill in the art without departing from the scope and spirit of the described aspects. The terminology used herein was chosen to best explain the principles of the aspects, the practical application or technical improvement over technologies found in the marketplace, or to enable others of ordinary skill in the art to understand the aspects disclosed herein.

Aspects described herein may take the form of an entirely hardware aspect, an entirely software aspect (including firmware, resident software, micro-code, etc.) or an aspect combining software and hardware aspects that may all generally be referred to herein as a “circuit,” “module” or “system.”

The aspects described herein may be a system, a method, and/or a computer program product. The computer program product may include a computer readable storage medium (or media) having computer readable program instructions thereon for causing a processor to carry out aspects described herein.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some aspects, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects described herein.

Aspects are described herein with reference to flowchart illustrations and/or block diagrams of methods, apparatus (systems), and computer program products according to aspects. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various aspects. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Aspects described herein may be provided to end users through a cloud computing infrastructure. Cloud computing generally refers to the provision of scalable computing resources as a service over a network. More formally, cloud computing may be defined as a computing capability that provides an abstraction between the computing resource and its underlying technical architecture (e.g., servers, storage, networks), enabling convenient, on-demand network access to a shared pool of configurable computing resources that can be rapidly provisioned and released with minimal management effort or service provider interaction. Thus, cloud computing allows a user to access virtual computing resources (e.g., storage, data, applications, and even complete virtualized computing systems) in “the cloud,” without regard for the underlying physical systems (or locations of those systems) used to provide the computing resources.

Typically, cloud computing resources are provided to a user on a pay-per-use basis, where users are charged only for the computing resources actually used (e.g. an amount of storage space consumed by a user or a number of virtualized systems instantiated by the user). A user can access any of the resources that reside in the cloud at any time, and from anywhere across the Internet. In context of at least one aspect, a user may access applications (e.g., the payload tracking application 712) or related data available in the cloud. For example, the payload tracking application 712 could execute on a computing system in the cloud and output the graphical icons (e.g., icons 110, 120, and 130) for display on a computer display. Doing so allows a user to access this information from any computing system attached to a network connected to the cloud (e.g., the Internet).

While the foregoing is directed to certain aspects, other and further aspects may be devised without departing from the basic scope thereof, and the scope thereof is determined by the claims that follow.

What is claimed is:

1. A system, comprising:
a computer processor;
an input operable to receive:
first indications of positions and directions of travel of a first vehicle; and
second indications of statuses of a first deployable payload onboard the first vehicle;
a computer memory storing:
a computer-generated image of a region in which the first vehicle is operating; and
an application that, when executed by the computer processor:
generates a first graphical icon, the first graphical icon comprising:
a first icon portion indicating the statuses of the first deployable payload; and
a second icon portion indicating the first vehicle, wherein the second icon portion is arranged relative to the first icon portion based on the direction of travel of the first vehicle, and wherein the second icon portion is smaller than the first icon portion; and
outputs the computer-generated image with the generated first
graphical icon superimposed on the generated computer image at a location
that coincides with the position of the first vehicle; and
a computer display operable to display the output computer-generated image and the generated first graphical icon.

2. The system of claim 1, wherein the input is further operable to receive third indications of positions and directions of travel of a second vehicle and fourth indications of statuses of a second deployable payload onboard the second vehicle; wherein the application is further executable to:
generate a second graphical icon, the second graphical icon comprising:
a third icon portion indicating the status of the second deployable payload;
a fourth icon portion indicating the second vehicle, wherein the fourth icon portion is arranged relative to the third icon portion based on the first indication of the direction of travel of the first vehicle, and wherein the fourth icon portion is smaller than the third icon portion; and
output the computer-generated image with the generated second graphical icon superimposed on the generated computer image at a location that coincides with the position of the second vehicle and with the generated second graphical icon superimposed on the computer-generated image at a location that coincides with the position of the second vehicle; and
wherein the computer display is operable to display the output computer-generated image, the generated first graphical icon, and the second graphical icon.

3. The system of claim 1, wherein the memory further stores:
a first plurality of icons, wherein the first plurality of icons are related to respective types of vehicles;
a second plurality of icons, wherein the second plurality of icons are related to respective types of deployable payloads; and
wherein the first indications of positions and directions of travel of the first vehicle include a type of vehicle;
wherein the second indications of statuses of the first deployable payload include one or more types of sub-payloads included in the first deployable payload;
wherein the first icon portion includes an icon from the first plurality of icons corresponding to the indicated type of vehicle; and
wherein the second icon portion includes at least one icon from the second plurality of icons corresponding to the types of sub-payloads included in the first deployable payload.

4. The system of claim 1, wherein computer memory further stores a planned route for the first vehicle, wherein the planned route includes one or more deployment markers indicating locations where at least portions of the first deployable payload is to be deployed, and wherein the application outputs the planned route superimposed on the computer-generated image.

5. The system of claim 4, wherein the computer memory stores unique identifiers that are associated with the one or more deployment markers, wherein the first deployable payload includes a plurality of deployable sub-payloads, wherein the computer memory stores identifiers corresponding to the unique identifiers for the respective deployment markers, and wherein the application generates the first icon portion to include a plurality of graphical tiles, and wherein the graphical tiles include identifiers corresponding to the unique identifiers for the respective deployment markers.

6. A computer program product for calculating a predicted abnormal operation of a machine, the computer program product comprising:
a computer-readable storage medium having computer-readable program code embodied therewith, the computer-readable program code executable by one or more computer processors to:
receive a first indication of a position and direction of travel of a first vehicle;
receive a second indication of a status of a first deployable payload onboard the first vehicle;
generate a first graphical icon, the first graphical icon comprising:
a first icon portion indicating the status of the first deployable payload; and
a second icon portion indicating the first vehicle, wherein the second icon portion is arranged relative to the first icon portion based on the direction of travel of the first vehicle, and wherein the second icon portion is smaller than the first portion;
generate a computer image indicating a region in which the first vehicle is operating; and
output to a computer display the generated computer image and the generated first graphical icon, wherein the generated first graphical icon is superimposed on the generated computer image at a location that coincides with the position of the first vehicle.

7. The computer program product of claim 6, wherein the computer-readable program code is further executable to:
receive at least one of:
a revised first indication based on at least one of a changed position of the vehicle and a changed direction of travel of the vehicle; and
a revised second indication based on a change to the status of the first deployable payload;
generate a revised first graphical icon based on the received at least one of the revised first indication and the revised second indication; and
output to the computer display the generated computer image and the revised generated first graphical icon, wherein the wherein the revised generated first graphical icon is superimposed on the generated computer image at a location that coincides with the changed position of the first vehicle.

8. The computer program product of claim 6, wherein the computer-readable program code is further executable to:
receive a third indication of a position and direction of travel of a second vehicle;
receive a fourth indication of a status of a second deployable payload onboard the second vehicle;
generate a second graphical icon, the second graphical icon comprising:
a third icon portion indicating the status of the second deployable payload; and
a fourth icon portion indicating the second vehicle, wherein the fourth icon portion is arranged relative to the third icon portion based on the first indication of the direction of travel of the second vehicle, and wherein the fourth icon portion is smaller than the third portion; and
further output to the computer display the generated second graphical icon, wherein the generated second graphical icon is superimposed on the generated computer image at a location that coincides with the position of the second vehicle.

9. The computer program product of claim 6, wherein the first deployable payload includes a plurality of deployable sub-payloads, wherein the first icon portion includes a plurality of graphical tiles, and wherein the plurality of graphical tiles correspond to respective ones of the plurality of deployable sub-payloads.

10. The computer program product of claim 9, wherein the graphical tiles have a first graphical state when the respective deployable sub-payloads are in an undeployed state and have a second graphical state when the respective deployable sub-payloads are in a deployed state.

11. A computer-implemented method for generating an icon, comprising:
receiving a first indication of a position and direction of travel of a first vehicle;
receiving a second indication of a first status of a first deployable payload onboard the first vehicle;
generating a first graphical icon, the first graphical icon comprising:
a first icon portion indicating the status of the first deployable payload; and
a second icon portion indicating the first vehicle, wherein the second icon portion is arranged relative to the first icon portion based the direction of travel of the first vehicle, and wherein the second icon portion is smaller than the first icon portion;
generating a computer image indicating a region in which the first vehicle is operating; and
outputting to a computer display the generated computer image and the generated first graphical icon, wherein the generated first graphical icon is superimposed on the generated computer image at a location that coincides with the position of the first vehicle.

12. The computer-implemented method of claim 11, further comprising:
receiving at least one of:
a revised first indication based on at least one of a changed position of the vehicle and a changed direction of travel of the first vehicle; and
a revised second indication based on a change to the status of the first deployable payload;
generating a revised first graphical icon based on the received at least one of the revised first indication and the revised second indication; and
outputting to the computer display the generated computer image and the revised generated first graphical icon, wherein the wherein the revised generated first graphical icon is superimposed on the generated computer image at a location that coincides with the changed position of the first vehicle.

13. The computer-implemented method of claim 11, further comprising:
receiving a third indication of a position and direction of travel of a second vehicle;
receiving a fourth indication of a second status of a second deployable payload onboard the second vehicle;
generating a second graphical icon, the second graphical icon comprising:
a third icon portion indicating the status of the second deployable payload; and
a fourth icon portion indicating the second vehicle, wherein the fourth icon portion is arranged relative to the third icon portion based on the first indication of the direction of travel of the second vehicle, and wherein the fourth icon portion is smaller than the third icon portion; and
further outputting to the computer display the generated second graphical icon, wherein the generated second graphical icon is superimposed on the generated computer image at a location that coincides with the position of the second vehicle.

14. The computer-implemented method of claim 11, wherein the first deployable payload includes a plurality of deployable sub-payloads, wherein the first icon portion includes a plurality of graphical tiles, and wherein the plurality of graphical tiles correspond to respective ones of the plurality of deployable sub-payloads.

15. The computer-implemented method of claim 14, wherein the graphical tiles have a first graphical state when the respective deployable sub-payloads are in an undeployed state and have a second graphical state when the respective deployable sub-payloads are in a deployed state.

16. The computer-implemented method of claim 14, wherein the graphical tiles are a first graphical sub-state when the respective deployable sub-payloads are in a ready-for-deployment state and are a second graphical sub-state when the respective deployable sub-payloads are in a not-ready-for-deployment state.

17. The computer-implemented method of claim 16, wherein the graphical tiles are a third graphical sub-state when the respective deployable sub-payloads are in a readying-for-deployment state.

18. The computer-implemented method of claim 11, further generating a planned route of the first vehicle, wherein the planned route includes one or more deployment markers indicating locations where at least portions of the first deployable payload is to be deployed.

19. The computer-implemented method of claim 18, wherein one or more deployment markers include unique identifiers, wherein the first deployable payload includes a plurality of deployable sub-payloads, wherein the first icon portion includes a plurality of graphical tiles, and wherein the graphical tiles include identifiers corresponding to the unique identifiers for the respective deployment markers.

20. The computer-implemented method of claim 11, wherein the first deployable payload includes a plurality of deployable sub-payloads, wherein the first icon portion includes a plurality of graphical tiles, and wherein the graphical tiles are sized relative to each other based on portions of a payload capacity of the first vehicle used by the respective sub-payloads.
